(19) United States
(12) Patent Application Publication
(10) Pub. No.: US 2010/0090173 A1
(43) Pub. Date: Apr. 15, 2010

(54) Process of Producing Negative Electrode Material for Lithium-Ion Secondary Batteries

(76) Inventors: Mitsuaki Dohzono, Tokyo (JP); Masatake Yamamoto, Tokyo (JP); Satoshi Hiugano, Tokyo (JP); Kentaro Takizawa, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 12/086,654

(22) PCT Filed: Dec. 8, 2006
(86) PCT No.: PCT/JP2006/324992

§ 371 Date: Dec. 7, 2009

(30) Foreign Application Priority Data
Dec. 28, 2005 (JP) 2005-377139

(51) Int. Cl. H01B 1/24

(52) U.S. Cl. 252/510

(57) ABSTRACT

A process is disclosed which produces a negative electrode material for lithium-ion secondary batteries that has a small irreversible capacity and a large reversible capacity by suppressing exposure of an active graphite surface due to grinding. The process includes melt-mixing graphite particles, pitch having a quinoline insoluble content of 0.3% or less and a fixed carbon content of 50% or more, and a fusible organic substance that volatilizes by 50% or more when heated to 400° C. in the air and has a residual carbon content of 3% or less when heated to 800° C. in an inert atmosphere, carbonizing the mixture by firing, graphitizing the carbonized product, and grinding the graphitized product. It is preferable that the graphite particles and the pitch be mixed in such a ratio that the amount of the pitch is 25 to 40 parts by weight based on 100 parts by weight of the graphite particles, and a formed product obtained by forming mixture be carbonized by firing, graphitized, and ground.

### TECHNICAL FIELD

The present invention relates to a process of producing a negative electrode material for lithium-ion secondary batteries that has a small irreversible capacity and a large reversible capacity.

### BACKGROUND ART

A lithium-ion secondary battery has a reduced weight and a high energy density. Therefore, the lithium-ion secondary battery has been considered to be a promising portable instrument drive power supply, power storage battery, and the like, and has been extensively studied. A carbon material has been used as a negative electrode material for the lithium-ion secondary battery. In particular, a graphite material has a high charge/discharge efficiency due to high lithium ion insertion/extraction reversibility, has a high theoretical capacity of 372 mAh/g, and enables production of a high-voltage battery due to a potential almost equal to that of lithium during charging/discharging, for example.

A graphite material that is highly graphitized and has a highly developed hexagonal carbon structure has a large capacity, but has a large irreversible capacity since an electrolyte decomposition reaction is likely to occur.

Since graphite particles are bonded in the plane direction to a large extent as compared with the thickness direction, a flake-like particle shape with a large aspect ratio is necessarily obtained. When using such flake-like graphite particles as the negative electrode material for a lithium-ion secondary battery, the graphite particles tend to be oriented in parallel to the electrode surface.

In a lithium-ion secondary battery, lithium ions are inserted or extracted through the end faces of graphite particles. Therefore, if the graphite particles are oriented in parallel to the electrode surface, the contact area between the end face (lithium ion passage) of the graphite particles and an electrolyte decreases. As a result, the lithium ion insertion/extraction rate is limited during a rapid charging/discharging process, whereby the capacity decreases rapidly.

Since the graphite particles expand or contract by about 10% when insertion/extraction of lithium ions occurs during charging/discharging, the adhesion between the particles is subjected to stress during a repeated charging/discharging process so that the battery capacity tends to undergo cycle deterioration.

In order to solve the above-described problems, attempts have been made that combine a graphite material with a high degree of graphitization and a carbonaceous substance with a low degree of graphitization by improving the properties of a carbon material such as a graphite material. For example, a carbon material obtained by covering the surface of graphite particles with a high degree of graphitization by low-crystalline carbon with a low degree of graphitization has been proposed.

For example, JP-A-11-011918 discloses a negative electrode for lithium-ion secondary batteries which is obtained by adding an organic binder and a solvent to graphite particles, mixing the components to obtain a graphite paste, applying the graphite paste to a collector, and integrating the product, wherein the graphite particles are produced by mixing graphite with a binder, carbonizing the binder by firing the mixture in a non-oxidizing atmosphere, and grinding the resulting product.

JP-A-11-171519 discloses a process of producing a graphite powder suitable for lithium-ion secondary batteries, wherein a graphite precursor (formed product) having a bulk density of 1.6 g/cm³ or less that contains at least one component that volatilizes at 400 to 3200° C. is graphitized.

The surface-modified carbon material disclosed in JP-A-11-011918 is effective for suppressing a decrease in battery capacity and deterioration in cycle characteristics since decomposition of an electrolyte is suppressed due to the carbon on the surface. However, since graphite particles are strongly bonded and aggregate when pitch or the like is applied to graphite and carbonized, the graphite particles must be ground. Since an active graphite surface is exposed due to grinding, the irreversible capacity increases, for example. The carbon material disclosed in JP-A-11-171519 shows an improved grinding capability. However, since the specific surface area increases due to a component that volatilizes after thermal polymerization of pitch, it is difficult to control a cell reaction.

### DISCLOSURE OF THE INVENTION

The present invention was conceived in order to solve the above-described problems relating to a negative electrode material for lithium-ion secondary batteries. An object of the present invention is to provide a process of producing a negative electrode material for lithium-ion secondary batteries that has a small irreversible capacity and a large reversible capacity by suppressing exposure of an active graphite surface due to grinding.

A process of producing a negative electrode material for lithium-ion secondary batteries according to the present invention which achieves the above object comprises melt-mixing graphite particles, pitch having a quinoline insoluble content of 0.3% or less and a fixed carbon content of 50% or more, and a fusible organic substance that volatilizes by 50% or more when heated to 400° C. in the air and has a residual carbon content of 3% or less when heated to 800° C. in an inert atmosphere, carbonizing the mixture by firing, graphitizing the carbonized product, and grinding the graphitized product.

In this process of producing a negative electrode material for lithium-ion secondary batteries, it is preferable that the graphite particles and the pitch be mixed in such a ratio that the amount of the pitch is 25 to 40 parts by weight based on 100 parts by weight of the graphite particles, and a formed product obtained by forming the mixture be carbonized by firing, graphitized, and ground.

According to the production process of the present invention, the amount of pitch can be reduced by adding an organic substance having specific properties when mixing the pitch (low-crystalline carbon precursor) with the graphite particles. Moreover, since the grinding capability is improved when grinding the mixture subjected to carbonization by firing and graphitization, an increase in irreversible capacity due to a graphite crystal surface exposed due to grinding can be suppressed.

### BEST MODE FOR CARRYING OUT THE INVENTION

In the present invention, natural graphite particles or artificial graphite particles may be used as the graphite particles. It is preferable that the graphite particles have an average particle diameter of 10 to 25 μm. If the average particle diameter of the graphite particles is less than 10 μm, it may be difficult to obtain an electrode with a high density due to a decrease in filling density. Moreover, the irreversible capacity may increase due to an increase in specific surface area. If the average particle diameter of the graphite particles is more than 25 μm, a rapid charging/discharging process may become difficult due to an increase in the diffusion distance between lithium ions in the graphite particles.

As the pitch, fusible pitch having a quinoline insoluble content of 0.3% or less and a fixed carbon content of 50% or more is used. A quinoline insoluble component hinders graphitization when effecting carbonization by firing and graphitization, thereby decreasing the electrical capacity of the resulting negative electrode material.

Therefore, the quinoline insoluble content of the pitch is limited to 0.3% or less. The quinoline insoluble content is adjusted by removing a quinoline insoluble component by solvent extraction, centrifugation of the raw material tar, or the like.

The pitch used in the present invention has a fixed carbon content of 50% or more. If the fixed carbon content is less than 50%, a large number of pores may be formed when a volatile component volatilizes during carbonization by firing. As a result, the irreversible capacity of the resulting lithium-ion secondary battery may increase due to an increase in specific surface area.

The quinoline insoluble content and the fixed carbon content are measured by the following methods.
Quinoline insoluble content: JIS K 2425-1983 “Methods of determining quinoline insoluble content of tar pitch”
Fixed carbon content: JIS K 2425-1983 “Methods of determining fixed carbon content”

It is preferable to use fusible pitch having a softening point of 70° C. or more. If the softening point of the pitch is less than 70° C., the fixed carbon content may decrease. As a result, the above-described problem may occur.

When mixing the graphite particles and the pitch, an organic substance that volatilizes by 50% or more when heated to 400° C. in the air and has a residual carbon content of 3% or less when heated to 800° C. in an inert atmosphere is added. The components are then melt-mixed.

When mixing the graphite particles and the pitch, the organic substance must be melted to have a reduced viscosity. Therefore, a fusible organic substance is used as the organic substance. It is preferable that the organic substance have a low molecular weight. The subsequent carbonization process is performed by firing the mixture in a non-oxidizing atmosphere that does not contain oxygen (air). Oxygen around the firing target product is removed due to the gas pressure which occurs when the organic substance contained in the firing target product volatilizes, or the organic substance reacts with oxygen to decrease the oxygen concentration. Therefore, an organic substance that volatilizes by 50% or more when heated to 400° C. in the air is used. If the volatile content is less than 50%, the oxygen concentration around the firing target product may not be sufficiently decreased. As a result, the crystallinity of pitch-based carbon may decrease, whereby the reversible capacity may decrease.

The graphite particles and the pitch are mixed so that the amount of the pitch is 25 to 40 parts by weight based on 100 parts by weight of the graphite particles. If the amount of the pitch is less than 25 parts by weight, it may be difficult to uniformly cover the surface of the graphite particles. If the amount of the pitch is more than 40 parts by weight, the graphite particles are strongly fusion-bonded, whereby the grinding capability may decrease. This may require a large amount of force when grinding the graphite particles to a desired grain size, whereby an active graphite surface may be exposed due to grinding. Moreover, the irreversible capacity may increase due to an increase in specific surface area.

Since the residual carbon in the fusible organic substance decreases the reversible capacity, it is desirable that the residual carbon content of the fusible organic substance be as low as possible. Therefore, an organic substance having a residual carbon content of 3% or less when heated to 800° C. in an inert atmosphere is used.

It is preferable to add the fusible organic substance in an amount of 3 to 10 parts by weight based on 100 parts by weight of the graphite particles. If the amount of the fusible organic substance is less than 3 parts by weight, it may be difficult to uniformly mix the fusible organic substance. Moreover, the anti-oxidation effect during firing may become insufficient. If the amount of the fusible organic substance is more than 10 parts by weight, a large number of pores may be formed when a volatile component volatilizes. As a result, the irreversible capacity increases due to an increase in specific surface area.

Examples of the fusible organic substance include synthetic oil, natural oil, stearic acid, synthetic wax, natural wax, and the like.

A mixture obtained by mixing the graphite particles, the pitch, and the fusible organic substance in a given ratio is further mixed at 100 to 250° C. so that the pitch and the fusible organic substance are melted. The components are sufficiently mixed using an appropriate mixer such as a heating kneader. It is preferable to sufficiently mix the components so that the molten pitch infiltrates the graphite particles and covers the surface of the graphite particles.

In this case, the graphite particles, the pitch, and the fusible organic substance may be mixed at the same time. Alternatively, the fusible organic substance may be added after the molten pitch has uniformly covered the surface of the graphite particles, or the fusible organic substance may be added before adding the fusible pitch.

The molten mixture is carbonized by firing the mixture at 800° C. or more in a non-oxidizing atmosphere, and is then graphitized by heating the mixture at 2500° C. or more. The resulting product is ground using a grinder such as a vibrating ball mill, a jet grinder, a roller mill, or an impact grinder.

In this case, instead of directly subjecting the molten mixture to carbonization by firing, graphitization, and grinding, a formed product obtained by placing the mixture in an appropriate mold and thermocompression forming or extruding the mixture may be carbonized by firing, graphitized, and then ground in order to increase the grinding efficiency.

When directly subjecting the molten mixture to carbonization by firing and graphitization, the resulting product is ground using an appropriate grinder (e.g., vibrating ball mill, jet grinder, roller mill, or impact grinder), and sieved out using a classifier to adjust to the average particle diameter to 11 to 28 μm. When grinding a formed product, it is preferable to roughly grind the formed product using a hydraulic or a motor grinder in advance, and then grind the resulting product.

A negative electrode material for lithium-ion secondary batteries that has a small irreversible capacity and a large reversible capacity can thus be produced.

### Examples

The present invention is described in detail below by way of examples and comparative examples. Note that the following examples illustrate one embodiment of the present invention, and should not be construed as limiting the present invention.

### Example 1

A Werner mixer (capacity: 2 liters) was charged with 500 g natural graphite having an average particle diameter of 20.2 μm and 175 g of coal pitch having a quinoline insoluble content of 0.2% and a fixed carbon content of 52%. The components were mixed at 130° C. for 20 minutes. After the addition of 25 g of fusible machine oil that volatilized by 70% when heated to 400° C. in the air and had a residual carbon content of 0.6% when heated to 800° C. in an inert atmosphere as a fusible organic substance, the components were melt-mixed for 10 minutes.

After cooling the resulting mixture, the mixture was placed in a graphite crucible, and carbonized by firing the mixture at 1000° C. in a nitrogen gas atmosphere. The resulting product was placed in a graphitization furnace, and graphitized at 2500° C. The graphitized product was ground using a cyclone sample mill “CSM-F 1” (manufactured by Fujiwara Scientific Co., Ltd.), and sieved out using a screen with a pore size of 44 μm to adjust the average particle diameter to 20.8 μm.

### Example 2

The components were melt-mixed in the same manner as in Example 1, except for using stearic acid that volatilized by 63% when heated to 400° C. in the air and had a residual carbon content of 0.4% when heated to 800° C. in an inert atmosphere instead of the fusible machine oil. The mixture was carbonized by firing, graphitized, and sieved out to adjust the average particle diameter to 20.9 μm in the same manner as in Example 1.

### Example 3

The components were melt-mixed in the same manner as in Example 1, except for using coal tar having a quinoline insoluble content of 0.2% and a fixed carbon content of 55%, and using stearic acid that volatilized by 63% when heated to 400° C. in the air and had a residual carbon content of 0.4% when heated to 800° C. in an inert atmosphere instead of the fusible machine oil. The mixture was carbonized by firing, graphitized, and sieved out to adjust the average particle diameter to 20.9 μm in the same manner as in Example 1.

### Example 4

The components were melt-mixed in the same manner as in Example 1, except for using coal tar having a quinoline insoluble content of 0.3% and a fixed carbon content of 52%, and using stearic acid that volatilized by 63% when heated to 400° C. in the air and had a residual carbon content of 0.4% when heated to 800° C. in an inert atmosphere instead of the fusible machine oil. The mixture was carbonized by firing, graphitized, and sieved out to adjust the average particle diameter to 20.4 μm in the same manner as in Example 1.

### Comparative Example 1

The components were melt-mixed in the same manner as in Example 1, except that the fusible machine oil (fusible organic substance) was not used. The mixture was carbonized by firing, graphitized, and sieved out to adjust the average particle diameter to 21.3 μm in the same manner as in Example 1.

### Comparative Example 2

The components were melt-mixed in the same manner as in Example 1, except that coal tar having a quinoline insoluble content of 10% and a fixed carbon content of 55% was used and the fusible machine oil (fusible organic substance) was not used. The mixture was carbonized by firing, graphitized, and sieved out to adjust the average particle diameter to 21.4 μm in the same manner as in Example 1.

### Comparative Example 3

The components were melt-mixed in the same manner as in Example 1, except for using PVC that volatilized by 60% when heated to 400° C. in the air and had a residual carbon content of 4.4% when heated to 800° C. in an inert atmosphere instead of the fusible machine oil. The mixture was carbonized by firing, graphitized, and sieved out to adjust the average particle diameter to 21.2 μm in the same manner as in Example 1.

### Comparative Example 4

The components were melt-mixed in the same manner as in Example 1, except for using coal tar having a quinoline insoluble content of 10% and a fixed carbon content of 55%, and using a pine resin that volatilized by 57% when heated to 400° C. in the air and had a residual carbon content of 3.3% when heated to 800° C. in an inert atmosphere instead of the fusible machine oil. The mixture was carbonized by firing, graphitized, and sieved out to adjust the average particle diameter to 21.0 μm in the same manner as in Example 1.

A battery was assembled using the graphite particles thus produced as a negative electrode material. The battery characteristics were measured by the following method.

### Irreversible Capacity and Reversible Capacity

Polyvinylidene fluoride (PVDF) dissolved in N-methyl-2-pyrrolidone was added to the graphite particles in an amount of 10 wt % (solid content). The components were mixed to obtain a graphite paste. After applying the graphite paste to rolled copper foil having a thickness of 18 μm, the graphite paste was dried and then pressed by a roll press method to a density of 1.6 g/cm³. A three-electrode test cell was formed using the electrode thus obtained as a positive electrode, a lithium electrode as a negative electrode, and a lithium electrode as a reference electrode. After constantly charging the lithium reference electrode (inserting lithium ions into graphite) up to 0.002 V, the lithium reference electrode was constantly discharged (lithium ions were extracted from graphite) up to 1.2 V. The difference between the initial amount of charging and the initial amount of discharging was determined to be the irreversible capacity. The charging/discharging process was then repeated under the same conditions. The reversible capacity per 1 g of graphite was calculated from the amount of electricity discharged (lithium ions were extracted from graphite) during the tenth cycle. The results are shown in Table 1.

TABLE 1

| | Example | | | | Comparative Example | | | |
|---|---|---|---|---|---|---|---|---|
| | 1 | 2 | 3 | 4 | 1 | 2 | 3 | 4 |
| Graphite particles | | | | | | | | |
| Type | Natural | Natural | Natural | Natural | Natural | Natural | Natural | Natural |
| Average particle diameter (μm) | 20.2 | 20.2 | 20.2 | 20.2 | 20.2 | 20.2 | 20.2 | 20.2 |
| Binder | | | | | | | | |
| Type*¹ | P | P | T | T | P | T | P | T |
| Quinoline insoluble content (%) | 0.2 | 0.2 | 0.2 | 0.3 | 0.2 | 10 | 0.2 | 10 |
| Fixed carbon content (%) | 52 | 52 | 55 | 52 | 52 | 55 | 52 | 55 |
| Amount (parts) | 35 | 35 | 35 | 35 | 35 | 35 | 35 | 35 |
| Fusible organic substance | | | | | | | | |
| Type | M*² | Stearic acid | Stearic acid | Stearic acid | — | — | PVC | Pine resin |
| Volatile content (%) | 70 | 63 | 63 | 63 | — | — | 60 | 57 |
| Residual carbon content (%) | 0.6 | 0.4 | 0.4 | 0.4 | — | — | 4.4 | 3.3 |
| Amount (parts) | 5 | 5 | 5 | 5 | — | — | 5 | 5 |
| Graphite particles produced | | | | | | | | |
| Average particle diameter (μm) | 20.8 | 20.9 | 20.9 | 20.4 | 21.3 | 21.4 | 21.2 | 21.0 |
| Specific surface area (m²/g) | 2.5 | 2.3 | 2.4 | 2.3 | 4.1 | 3.9 | 4.0 | 4.1 |
| Battery characteristics | | | | | | | | |
| Irreversible capacity (mAh/g) | 24 | 23 | 28 | 29 | 38 | 36 | 37 | 29 |
| Reversible capacity (mAh/g) | 354 | 355 | 345 | 354 | 352 | 342 | 341 | 342 |

Note:
*¹P: pitch, T: tar,
*²fusible machine oil

As shown in Table 1, since the graphite particles of Examples 1 to 4 could be ground with a small amount of energy, the specific surface area decreased. As a result, the irreversible capacity could be decreased. In Comparative Examples 1 and 2, since the fusible organic substance was not added, a large amount of energy was required for grinding. As a result, the irreversible capacity increased due to an increase in specific surface area. In Comparative Examples 3 and 4, since the fusible organic substance had a high residual carbon content, the irreversible capacity increased while the reversible capacity decreased.

1. A process of producing a negative electrode material for lithium-ion secondary batteries, the process comprising melt-mixing graphite particles, pitch having a quinoline insoluble content of 0.3% or less and a fixed carbon content of 50% or more, and a fusible organic substance that volatilizes by 50% or more when heated to 400° C. in the air and has a residual carbon content of 3% or less when heated to 800° C. in an inert atmosphere, carbonizing the mixture by firing, graphitizing the carbonized product, and grinding the graphitized product.

2. The process according to claim 1, wherein the graphite particles and the pitch are mixed in such a ratio that the amount of the pitch is 25 to 40 parts by weight based on 100 parts by weight of the graphite particles.

3. The process according to claim 1, wherein a formed product obtained by forming the mixture is carbonized by firing, graphitized, and ground.
